(19) United States
(12) Patent Application Publication
(10) Pub. No.: US 2010/0129571 A1
(43) Pub. Date: May 27, 2010

(54) Method for making artificial turf

(75) Inventors: John H. Bearden, Woodstock, GA (US); Randal A. Enterkin, Woodstock, GA (US)

Correspondence Address: INVENTION PROTECTION ASSOCIATES, LLC, P.O. Box 3913, SHAWNEE, KS, 66203, US

(73) Assignee: PRECISIONJET, INC., Woodstock, GA (US)

(21) Appl. No.: 12/614,299

(22) Filed: Nov. 6, 2009

Related U.S. Application Data
(60) Provisional application No. 61/117,628, filed on Nov. 25, 2008.

(51) Int. Cl. A41G 1/00; B05D 1/36

(52) U.S. Cl. 428/17; 427/258

(57) ABSTRACT

An artificial athletic turf includes a backing having a top face and a bottom face, yarn tufted through the backing such that cut pile extends from the top face and backloops of yarn are closely adjacent the bottom face and a porous coat is disposed over the backloops and bottom face in order to bind the yarn to the backing The coating material is sprayed, under high pressure and in distinct particles, onto the bottom face of the tufted backing under conditions which cause sprayed particles to rapidly cure and, therefore, partially cohere to each other in a porous network in which coating material generally is not accumulated between the backloops and backing face and does not fill a significant proportion of the fiber pores existent in the backing

### BACKGROUND

The present invention generally relates to methods for producing synthetic grass, and it is specifically directed to an improved method of applying adhesive to a tufted backing material—a method that represents a more efficient process for producing an artificial athletic turf that possesses desirable qualities relative to its water permeability and dimensional stability.

Artificial turf has long been used as a playing surface for sports that are traditionally played on grass fields, such as football, baseball and soccer to name a few. In many parts of the country which experience exceedingly cold, rainy or dry weather during the times of year such sports are customarily played in organized leagues, an artificial turf playing surface can be virtually essential to playing outdoors. For example, an artificial turf may be preferable to natural grass for an outdoor football field in the Great Lakes region because of the tendency of a natural surface to harden and become more difficult to maintain as a consequence of the cold weather that the region experiences during the autumn football season. At the same time, in the Pacific Northwest, a water permeable synthetic surface may be preferable because of the water puddle formation and overall deterioration that a natural surface would exhibit due to excessive rainfall in that geographical region. Conversely, because the arid conditions of the desert Southwest require that considerable irrigation efforts be made in order to maintain natural grass fields, synthetic turf is often preferred as a football playing surface in that part of the country as well. Furthermore, an artificial turf surface makes it possible for sports traditionally performed on grass to be played inside climate controlled indoor facilities, as artificial turf does not require the exposure to sunlight needed to sustain natural grass.

Artificial athletic turf is generally comprised of at least one textile fabric backing through which filament yarn, which resembles grass is inserted via a tufting process, as well as a resilient base mat which provides underlying support to the tufted backing A tufting machine of some construct is used to insert loops of selected yarn into a backing sheet, and the yarn is then bonded thereto by applying a coating material to one side of the backing Typically, the tufting machine features a series of yarn-carrying, reciprocating needles which punch downward through the backing so that the delivered yarn may be caught by looper devices to form elongate yarn loops along the top side of the backing (i.e., the side of the backing which faces upward upon the turf's installation as a playing surface) as the needles returns upward and out of the backing After the needles reciprocate, the backing or needles shift so that the needles may repeat their stroke and form stitches, or backloops, along the bottom of the backing In this tufting process, yarn is selectively protruded through the backing to a depth that corresponds with the desired length of the simulated grass blades being formed, and the ends of the top side loops are severed to render cut piles. After tufting, usually, coating material is applied to the backloops in order to bond the tufted yarn to the backing with lock strength (i.e., the force required to pull a strand yarn out of the backing) sufficient to withstand the stresses of the athletic performance to take place on the turf. Alternatively, the backloops of thermoplastic yarns may be heated in order that they fuse to the backing

For field installation, the tuft-locked backing is usually placed atop a resilient base mat which helps to help cushion athletes' joints and give the synthetic turf surface a more natural feel. Additionally, a granular mix of small particles (typically, rubber and sand particles) may be poured atop the tufted backing to infill the space between synthetic grass blades. Aside from further improving resiliency, this infill material also imposes a protective barrier between the athletes' cleats and the backing fabric.

Again, it is generally necessary to coat the bottom of the tufted backing in order to prevent yarn from dislodging during athletic use, but doing so can pose challenges that the prior art has evolved in effort to overcome. Traditionally, a continuous solid film or viscous liquid layer of thermoplastic or thermosetting coating material has been applied to the bottom side of a backing sheet, and then heat is applied thereto in order to either solidify the liquid coating or to liquefy the solid coating so that it envelops the yarn backloops, seals the yarn insertion holes and then forms a solid layer upon being cured by cooling. In either case, the cured coating layer locks the tufts to the backing Furthermore, since the spacing of their individual woven fibers may cause some woven fabrics to exhibit poor dimensional stability under the stress of athletic activity, putting the backing fibers in a common matrix with a coating layer should improve the stableness of the turf and make it less prone to stretch or otherwise deform during use.

Conventional methods for applying coating material to an athletic turf backing can present potential drawbacks, though. First of all, while it is generally desired that a tufted pile structure made for home or office carpet use be water sealed, the opposite is true for that made for athletic use. As mentioned earlier, it is essential that water and other fluids be able to drain through an athletic turf. Therefore, assuming that the continuous coating layer adhered to an athletic turf backing is water impermeable, as tends to be the case when coating material is deposited onto the backing in a liquid or solid phase, the coated backing must undergo further processing to give it porosity. Specifically, drainage holes must be introduced into it. For artificial turfs that are infilled, as most contemporary sports turfs are, these drainage holes can present challenges. To wit, although the infill layer is a porous element, its individual particles can flow into and clog drainage holes within the backing, and may be able to further matriculate down into pores residing within a base layer of material underlying the backing. Consequently, in addition to diminishing the porosity of the turf, enough infill particles may eventually sift through the backing's drainage holes to necessitate a replenishing of infill material in order to prevent the playing condition of the turf from appreciably degrading. Finally, punching these needed drainage holes into a fabric backing may, to some degree, effectively offset the increase in dimensional stability that was achieved by coating it. So, over time, the cumulative effects of climate exposure and stress imposed by athletic use may cause the drainage holes to stretch and exacerbate problems associated with their presence. This simply accelerates the aforementioned maintenance demands, and ultimately, it shortens the useful life of the turf.

A well-known alternative method of achieving tuft lock in an artificial athletic turf applications involves thermally bonding to the backing a tufted, grass-simulating thermoplastic yarn in lieu of applying coating material. For example, U.S. Pat. No. 4,705,706 to Avery discloses a process of tufting yarn fabricated of thermoplastic material, such as polyethylene, into a backing fabricated of a material, such as nylon, which has a higher fusion point than does the yarn. After the tufting process, the bottom side of the backing is heated to a temperature not quite high enough to degrade the backing, but sufficient to melt the yarn backloops so that their inner surfaces can adhere to the adjacent backing surface, obviating the further need to apply a coating in order to achieve satisfactory tuft lock. However, because the pile yarn atop the tufted backing must be shielded from the heat being applied to the yarn backloops disposed below the backing layer, as a practical matter, it may be necessary to tuft the yarn into multiple layers of backing fabric that can, together, form an adequate heat sink. Therefore, the total cost of producing the turf product may be increased by the inclusion of a secondary backing sheet(s) that might not be needed if the yarn was bonded to the primary backing by way of separate coating material.

To overcome these disadvantages, methods for discretely applying coating onto the linear the rows of yarn backloops disposed along the bottom surface of a backing, while leaving space between tuft rows uncoated, have been developed in the prior art as well. For example, U.S. Pat. No. 6,726,976 to Dimitri discloses a method of producing a tufted pile which involves applying linear strips of binding material to a backing and, subsequently, tufting yarn through both the backing and binding material so that areas of the backing surface between the tufted yarn rows remain uncoated. Alternatively, Dimitri teaches the pre-tufting application of a continuous sheet of highly shrinkable thermoplastic binder material to a backing that, upon being heated post-tufting, will shrink so that binder material concentrates around the yarn backloops and leaves uncoated spaces along the backing surface. Similarly, U.S. Pat. No. 6,338,885 to Prevost discloses the proposition of depositing strips of coating material only onto rows of yarn backloops so that interstitial spaces between rows remain uncoated. Alternatively, Prévost teaches the placement of a comb-like device, which has fingers that fit within the channels between backstitch rows, over the bottom of a backing prior to applying coating material and then removing the device and the coating that is deposited onto it thereafter. The comb-like device shields the backing fabric between yarn rows from the applied coating so that it retains its permeability characteristics, and, depending on the backing fiber, the need to puncture drainage holes may be averted. Prevost also discloses the proposition of using a series of nozzles to apply thin lines of coating exclusively onto the yarn backstitch rows.

There are a couple of obvious benefits of depositing coating material only onto the yarn rows in order to achieve tuft lock, as such a practice minimizes production costs by reducing the amount of coating material consumed therein, and it eliminates the need to mechanically perforate the coated backing for drainage purposes—thereby avoids the above mentioned perils of doing so.

However, in order to be practiced in a remotely efficient, automated manner, previously disclosed methods for coating a backing sheet in such discontinuous fashion generally required the use of a coating machine possessing a series of several nozzles or solid strip applicators which are appropriately spaced to enable coating material to be deposited precisely onto the numerous longitudinal rows of yarn (or row paths yet to be tufted) along a backing sheet that is advanced below them. In fact, if a particular such machine features a series of fewer coating applicators than are the total number of yarn rows to be coated, then the backing necessarily must be run through the machine multiple times so that its applicators can be laterally shifted into positions for coating individual rows not coating during a previous run(s). Further complicating the issue are matters of tufted yarn rows being spaced differently, from one article of artificial turf to another, or of them being non-linear, as may be dictated by the particular athletic activities to be performed upon them or by graphic design considerations. Consequently, the coating applicators along a machine for applying a discontinuous coat must be spaced and/or shifted in accordance with the precise layout of yarn rows along a particular backing piece or pieces to be seamed together. Similarly, multiple different coat shielding devices may need to be substituted, from coating task to task, to accommodate the need for variations in finger spacing. This can demand tedious work in adjusting coating delivery and shielding mechanisms between coating tasks. Moreover, the proposition of applying coating material in alignment with non-linear tuft patterns can be even more daunting.

Therefore, it can be appreciated that there exists a need for an improved method for making artificial athletic turf—a method which renders a tufted backing sheet that is continuously coated to achieve tuft lock adequate for athletic use, yet exhibits the porosity of contemporary athletic turf without having been mechanically perforated specifically for drainage purposes. The present method for producing artificial athletic turf substantially fulfills this need.

### SUMMARY OF THE INVENTION

It is an object of the present invention to provide a method for constructing artificial athletic turf in which execution of the step of applying a continuous, yet porous, tuft-locking coat to a backing may be precisely replicated on virtually every article of tufted backing, irrespective of the pattern or spacing of its tufts. Consequently, the present invention eliminates the need to adjust coating machinery or modify coating technique in accordance with variations in tuft placement specifications of different articles of tufted backing

It is another object of the invention to create a synthetic turf product for use as an outdoor athletic turf without implementing any of the normal practices for achieving both tuft lock and sufficient drainage properties. Specifically, by employing a tuft locking technique that represents an unconventional step in conventional methods for producing artificial athletic turf, the present turf production method obviates the need to, for example, heat yarn tufts in order to tackify and thermoplastically bond them to the bottom face of a primary backing Consequently, the material cost associated with including a secondary backing that functions as a heat sink and protects the yarn pile which extends from the top face of the backing may be avoided. As another example, the present method renders unnecessary a precision driven coating dispenser that is capable of discretely placing thin lines of liquefied coating material precisely onto the spaced tuft rows formed within a particular backing. Alternatively, the instant method eliminates the additional step of perforating a continuously coated backing in order to recreate porosity after completing the steps of applying coating material to the backing and allowing the material to cure.

In one aspect of the invention, a turf product rendered by the current method comprises three main components that are common to artificial athletic turfs: (1) a water permeable backing member, (2) yarn that is tufted into the backing and (3) a porous layer of coating material that is disposed over the bottom face of the backing The backing may be of any type commonly used in athletic turf applications. The yarn should simulate natural grass, and it is tufted into the backing so as to form a pile along the top face of the backing and rows of yarn backloops along the bottom face. The coating material has the dual purposes of: (a) bonding together individual fibers that exist within the backloop portion of each tuft; and (b) bonding the tufts to the backing so that the tufts are not dislodged under the strains of athletic use. It is believed that a wide variety of sprayable adhesive materials could be used as coatings in the present turf construction. However, it is essential to the inventive concept that the chosen coating material be deposited onto the backing in discrete particles by way of a high pressure spray and that the coating composition and the spray environment conditions are such that those particles rapidly solidify upon their deposition. Furthermore, it is preferred that the coating material be sprayed in successive passes over the backing so that deposited coating particles partly cohere together in quasi-layered fashion to build a coating network that is contiguous, yet porous.

In another aspect of the invention, coating particles are sprayed at the backing such that their trajectory is generally perpendicular to the plane of the backing This enables the yarn backloops along the bottom face of the backing, merely by virtue of their positioning, to shield airborne coating particles from depositing onto the small surface areas of backing that underlie them. In addition, the coating composition is selected and the spray environment controlled such that multiple factors, which may include the dispersion pattern of sprayed coating particles, spray pressure, spray flight distance, ambient temperature and reactivity of the coating composition, cooperate to ensure that sprayed coating particles begin congealing in flight or immediately upon landing onto the backing, yarn backloops or previously landed coating particles. Resulting changes in phase and surface tension of sprayed coating particles, therefore, occurs rapidly enough to prevent extensive puddle formation or flow of coating material into those tight pockets defined between the backing surface and closely adjacent yarn backloops.

Depending upon the pattern density of coating droplets that directly deposit onto the backing surface and upon the weave density of the backing fabric itself, interstitial areas of backing between tuft rows may remain porous even after being continuously spray coated. Furthermore, the inability of coating material to accumulate underneath the backloops enables the backing fiber openings, which are created by yarn protrusion and are covered by backloops, to function as drainage apertures. That the present inventor is aware, no prior art method for producing artificial turf contemplates a coating step that, without clearly compromising tuft lock, would allow these fiber openings, invariably formed during the tufting step, to facilitate drainage. Moreover, the present inventor is unaware of any prior art artificial turf product that, like products of the present method, drain more robustly along their points of yarn insertion than along interstitial areas between tuft rows. The uniqueness of this characteristic of athletic turf produced by the present method is attributable to the fact that prior art methods for coating artificial athletic turf generally include a purposeful concentration of less viscous coating material underneath the yarn backloops, whereas, under the present method, those areas are purposely shielded from coating.

### BRIEF DESCRIPTION OF THE DRAWINGS

FIG. 1 is an exploded plan view of a small section of woven backing fabric;

FIG. 2 is a bottom perspective view of a section of tufted backing that is uncoated, the view showing cut pile yarn extending from the backing's top face and rows of yarn backloops along its bottom face;

FIG. 3 is an exploded bottom plan view showing a yarn backloop;

FIG. 4 is an exploded bottom perspective view of an intra-row pair of uncoated yarn backloops;

FIG. 5 is a is a bottom perspective view of a section of tufted backing that is coated;

FIG. 6 is an exploded bottom perspective view of a small section of tufted and coated backing, the view showing pores within the coating layer; and

FIG. 7 is a partial diagrammatic view of a coating formulation and delivery system, the view showing coating particles being sprayed toward the backing along a trajectory normal to the backing plane.

### DETAILED DESCRIPTION OF THE PREFERRED EMBODIMENTS

It should be understood that the present disclosure has particular applicability to the making of artificial turf that is intended for use as a sports playing surface, but can be applied to the manufacture of synthetic grass generally. This disclosure, as illustrated in the accompanying Figure drawings, relates to an artificial athletic turf comprising a backing 20 to which at least one yarn is mechanically adhered, first, via a tufting process and then via a spray coating process. Due to the particular way in which a layer 30 of coating material is built along its backing element 20 as shown in FIGS. 5-7, the turf remains adequately water permeable without that coating layer 30 having to be perforated after it is formed.

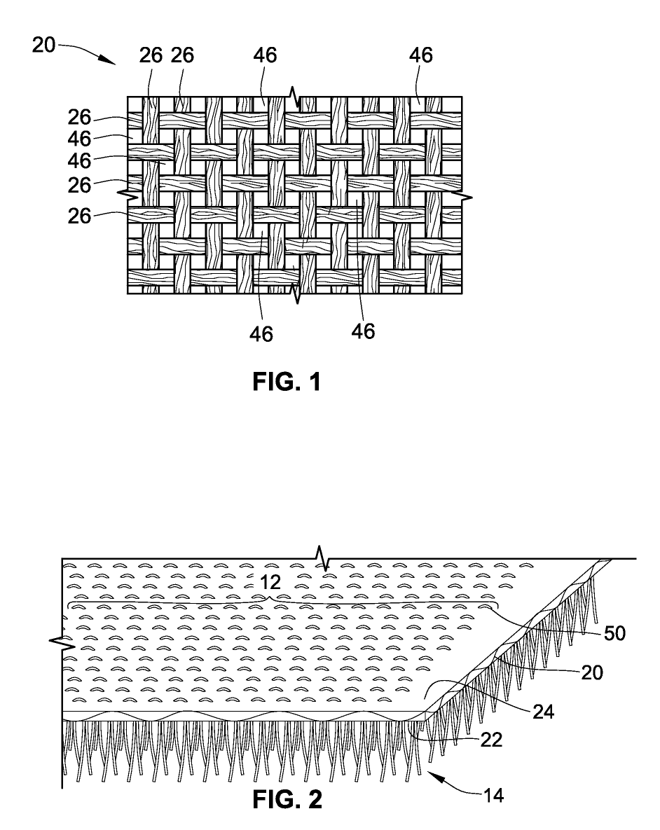

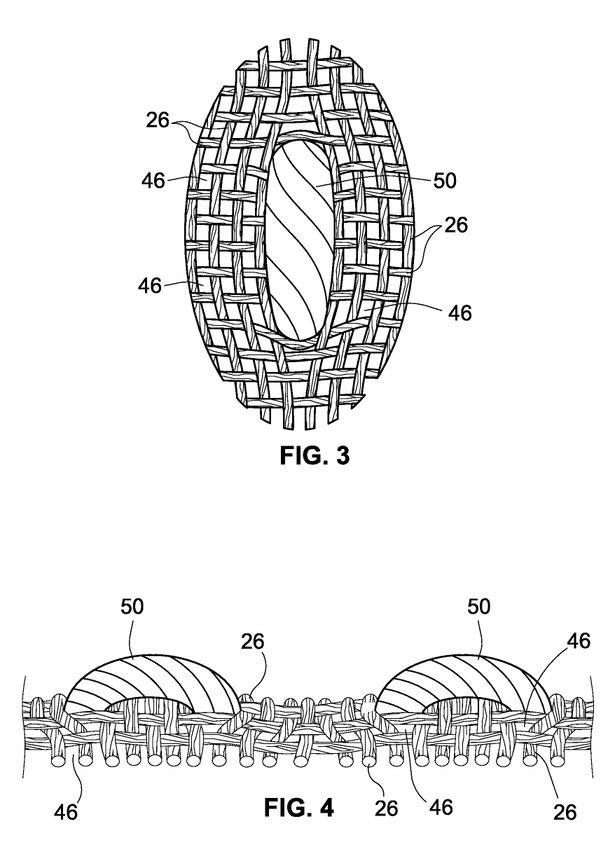

The backing 20 may be constructed of polypropylene fabric or any other fabric commonly used for athletic turf, and it should be woven (or perforated, in the case of a nonwoven fabric) so that, even prior to being tufted and coated, it exhibits the porosity characteristics generally required of an installation-ready outdoor athletic turf—most notably a water drain rate of at least 40 inches per hour. However, it is preferred that the untufted, uncoated backing 20 has a significantly greater drain rate due to the existence of fabric pores 46 throughout it, as can be seen in the section of backing fabric 20 shown in FIG. 1. The natural grass-simulating yarn may be fabricated of, for example, slit-film or monofilament polyethylene or polypropylene fibers that are twisted and bundled into strands. It is anticipated that a variety of sprayable materials, such as polyurethane, polyurea, a polyurethane/polyurea hybrid or even a hot melt adhesive, conceivably can be used to bind the yarn to the backing 20 within the concept of the present invention.

The yarn may be inserted into the backing 20 via any of a variety of conventional tufting processes. For example, the backing 20 may be intermittently conveyed underneath a series of vertically reciprocating, yarn-carrying needles (not shown) that are aligned transverse to the direction of conveyance. Alternatively, the backing 20 may be statically held while being operated upon by the advancing tufting head of a computer-operated, gantry-type tufting apparatus such as that described by the present inventor in U.S. Published Application No. 2008/0134949 published Jun. 12, 2008 and incorporated herein by reference. In either case, the relative positions of the backing 20 and needles shift between successive downward plunges of the needles through the backing 20 so as to create yarn backloops 50 that closely overlie the backing's bottom face 24. Parallel rows 12 of these backloops 50 are illustrated in FIG. 2. Simultaneously, with the aid of catch and cutting mechanisms (not shown), the reciprocating needles form elongate yarn loops along the top face 22 of the backing 20, which are then severed to form a cut pile 14 as is also shown in FIG. 2. As will be discussed, the present method includes a coating step designed to ensure that coating material does not concentrate in the tight spaces that exist between the backloops 50 and the backing 20 and that fluids, therefore, may drain through fabric pores 46 that are covered by backloops 50 and are not filled with coating material. Ideally, a significant proportion of backing fabric pores 46 that are situated between yarn rows 12 and not covered by yarn backloops 50 also remain unfilled, even though the backing's bottom face 24 is ostensibly blanketed by coating material.

Generally, the pattern in which yarn is to be tufted into a backing depends on the intended appearance of and/or use for the turf. In the manufacture of most articles of athletic turf, yarn is tufted such that its backloops 50 form parallel rows 12 like those seen in FIG. 2. However, to create a highly detailed visual design, it may be necessary to tuft yarn in non-linear patterns. Tuft row spacing is an even more prevalent subject of non-uniformity among turf products, as even within strictly linear tuft patterns, the precise spacing of parallel yarn rows 12 may depend upon the anticipated use for the turf For example, tuft rows 12 tend to be spaced further apart in football turfs, as football turfs are typically covered with an infill material mixture (not shown), such as a blend of sand and cryogenically ground rubber, which provides greater cushioning and abrasion resistance for athletes performing on them. Wider tuft spacing accommodates the infill mixture and helps to minimize the risk of athletes' cleats getting wedged and snagged between tufts of yarn—a phenomenon that often causes serious leg injury. On the other hand, yarn rows 12 may be tufted more narrowly in synthetic turf made for activities in which cleats are typically not used and for which a less forgiving playing surface is desired.

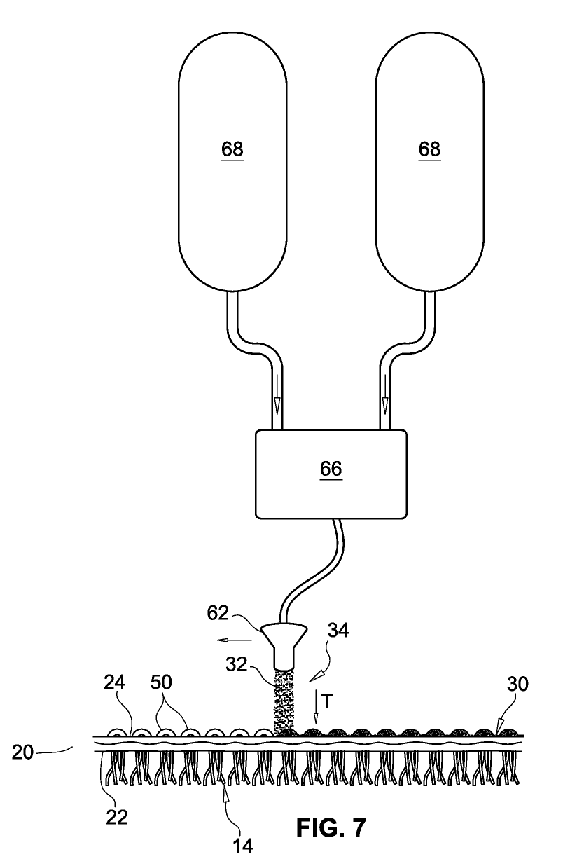

In order to bind tufted yarn to the backing 20 so that tufts are not dislodged from the turf during its use, an adhesive coating layer 30 is applied to the bottom face 24 of the backing 20. The present invention specifically requires that particles 32 of coating material be deposited onto the backing face 24 via a high pressure spray 34, and it generally calls for the spray trajectory “T” be perpendicular to the plane of the backing 20 immediately prior to deposition of the sprayed particles 32 so as to enable yarn backloops 50 to shield tiny areas of backing surface 24 disposed underneath them from the landing particles 32. This spray orientation is illustrated in FIG. 7. It should be noted that the present invention is distinguishable from conventional methods for coating artificial turf in that conventional methods almost universally call for an application of coating material in a manner of delivery and/or a state of matter that invariably results in the material completely engulfing the backloops 50 and accumulating underneath them—something that is deliberately avoided under the present method.

In addition to preventing airborne coating particles 32 from depositing between the backloops 50 and backing 20, a number of spray and environmental parameters must be precisely set, in consideration of the chemical reaction of the particular coating composition selected for use, to ensure that dispersedly deposited composition particles 32 solidify too quickly to reconstitute liquid masses that can flow along the backing 20 and concentrate in fabric pores 46 that the particles 32 did not initially land upon. Such parameters may include the spray pressure, the distance between a spray emitter 62 and the backing surface 24, the characteristics of relative movement of the spray emitter 62 and backing 20 and the ambient temperature of the spray environment.

A polyurethane composition is used as coating material in a preferred embodiment of the present turf construction, although, as previously mentioned, other rapidly curing compositions may be used instead. As partially schematically shown in FIG. 7, reaction monomers are separately held in fluid reservoirs 68 before being pumped into a mixing head 66 within which they are blended to react and form the polyurethane coating. While in a liquid state, the coating then advances to a spray head 62 that emits a high velocity shower 34 of coating droplets 32 onto the backing face 24 as the spray head 62 traverses over the backing 20. The spray head 62, in fact, may comprise one or more nozzles that are moveably mounted along a computer-operated, gantry-type coating apparatus (not shown) configured very similarly to the tufting machine referenced above and previously described by the present inventor in U.S. Published Patent App. No. 20080134949, except that, most notably, a spray head 62 replaces the tufting head of said machine. However, alternative means for controlling the spray head 62, including manual control, may be employed so long as they allow for careful control of the parameters of spray flight distance and relative movement of the spray head 62 and backing 20.

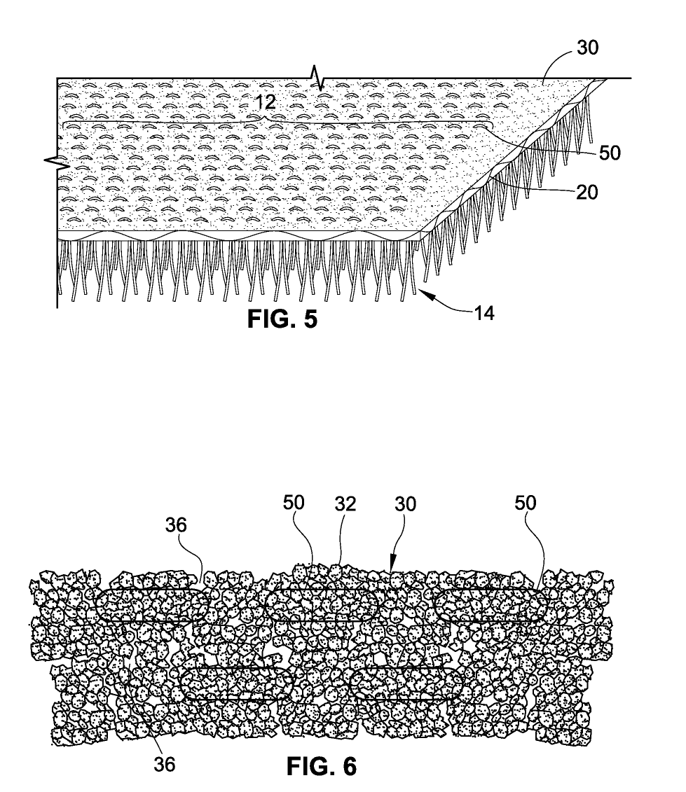

As previously mentioned, it is vitally important that sprayed coating particles 32 approach the backing 20 along a trajectory T that is substantially perpendicular to the backing 20 so that they are inhibited from landing underneath the backloops 50. As also previously mentioned, it is equally important that landed coating material 30 not accumulate under the backloops 50 by virtue of flowing along the backing 20. So that that phenomenon does not occur, the coating particles 32 should begin to cure immediately upon exiting the spray head 62 and become too viscous to flow along the fibrous backing 20 by the time they contact it. Also, if sprayed particles 32 deposit in a finely dispersed pattern, some fabric pores 46, aside from those covered by yarn backloops 50, may remain unfilled by coating material 30 as shown in FIG. 6. Accordingly, the moving spray head 62 should travel over the static backing 20 at a speed and from a distance that deposits a finely dispersed pattern of coating particles 32 onto the backing 20 with each pass.

Of course, in tension with the goal of applying coating material to the backing 20 in a manner that preserves the fabric's native porosity to any appreciable extent is the more essential requirement that the coating layer 30 sufficiently binds the tufted yarn to the backing 20. In other words, a delicate balance must be struck between, on the one hand, depositing coating particles 32 onto the backing 20 in a pattern disperse enough to leave some backing pores 46 unfilled and, on the other hand, depositing those coating particles 32 such that they adhere to backing fibers 26 and yarn backloops 50, and they cohere to each other in a matrix that locks the yarn to the backing 20. To those ends, it is desirable to produce an artificial turf that exhibits a water drain rate of at least 5 inches per minute and tuft bond strength of at least 12 pounds according to ANSI/ASTM D1335-67. Satisfying the latter desire requires that sprayed coating particles 32 which accumulate on the backing face 24 and on the backloops 50 do so with impact energy sufficient to penetrate into many of the backing fabric pores 46 and into the yarn fiber bundles of the backloops 50, but without further penetrating between the backloops 50 and backing face 24. It also demands that the spray head 62 make multiple passes over the backing 20. In so doing, fast solidifying coating particles 32 will partially cohere to each other in somewhat layered fashion to form a contiguous, yet porous, network layer 30 of coating that is rigid enough to achieve the desired tuft bond.

The present inventor has observed that, when using a polyurethane, the aforementioned coating objectives are best met by maintaining the following combination of spray parameters: (a) a spray head pressure within a range of 1,800 to 2,000 psi; (b) a spray distance within a range of 40 to 60 inches; (c) a spray head 62 travel speed of approximately 3 feet per second; (d) the coating material at a temperature of at least 130 degrees Fahrenheit within the mixing head 66; and (e) an ambient temperature within a range of 68 to 77 degrees Fahrenheit. It is further preferred that a suction device (not shown) be placed underneath the backing 20 (opposite the spray head 62) so that spray particulates neither escape into the ambient air nor accumulate on any other equipment used (e.g., hood enclosure, spray head, etc.).

It is understood that substitutions and equivalents for various elements set forth above may be obvious to those skilled in the art and may not represent a departure from the spirit of the invention. Therefore, the full scope and definition of the present invention is to be set forth by the claims that follow.

What is claimed is:

1. A method of making an artificial turf, the method comprising:
selecting a porous backing having a top face and an opposing bottom face;
selecting a yarn to tuft into the backing;
selecting a coating material to bond the yarn to the backing;
tufting the yarn into the backing to form grass blade-simulating yarn piles projecting from the top face and yarn backloops closely adjacent the bottom face;
spraying particles of coating material over the bottom face, wherein the sprayed particles deposit in a finely dispersed pattern, wherein viscosity of the deposited coating material causes it to resist flowing and puddling along the backing and, therefore, some backing pores are left unfilled with coating material; and
wherein the coating material forms a porous layer that bonds the tufted yarn to the backing

2. The method of claim 1, wherein the spray path is normal to the plane of the backing, and the backloops generally shield sprayed coating particles from depositing between themselves and the bottom face.

3. The method of claim 1, wherein the backing is moved relative to a spray mechanism, or vice versa, during spray coating.

4. The method of claim 1, wherein spray flight distance is 40 to 60 inches

5. The method of claim 1, wherein spray pressure is 1,800 to 2,000 psi.

6. The method of claim 1, wherein the coating material comprises at least one of the following: polyurethane, polyurea, a polyurethane/polyurea hybrid or a hot melt adhesive.

7. The method of claim 6, wherein the temperature of the coating material is at least 130 degrees Fahrenheit prior to expelling from a spray mechanism, and the ambient air is approximately room temperature.

8. A method of making an artificial turf, the method comprising:
selecting a porous backing having a top face and an opposing bottom face;
selecting a yarn to tuft into the backing;
selecting a coating material to bond the yarn to the backing;
tufting the yarn into the backing to form grass blade-simulating yarn piles projecting from the top face and yarn backloops closely adjacent the bottom face;
spraying a first coat of the coating material over the bottom face, wherein the first coat comprises particles of coating material that deposit in a finely dispersed pattern, wherein viscosity of the deposited coating material causes it to resist flowing and puddling along the backing and, therefore, some backing pores are left unfilled with coating material;
spraying a second coat of the coating material over the bottom face, wherein the second coat comprises particles of coating material that deposit in a finely dispersed pattern; and
wherein the cumulative coats form a porous, substantially contiguous network of coating material that bonds the tufted yarn to the backing while some backing pores remain unfilled with coating material.

9. The method of claim 8, wherein the spray paths of the coats are normal to the plane of the backing, and the backloops generally shield sprayed particles from depositing between themselves and the bottom face.

10. The method of claim 8, wherein the backing is moved relative to a spray mechanism, or vice versa, during spray coating.

11. The method of claim 8, wherein spray flight distance for the first coat is 40 to 60 inches

12. The method of claim 8, wherein spray pressure for the first coat is 1,800 to 2,000 psi.

13. The method of claim 8, wherein the coating material comprises at least one of the following: polyurethane, polyurea, a polyurethane/polyurea hybrid or a hot melt adhesive.

14. The method of claim 13, wherein the temperature of the coating material is at least 130 degrees Fahrenheit prior to expelling from a spray mechanism, and the ambient air is approximately room temperature.

15. An artificial turf comprising:
a porous backing having a top face and an opposing bottom face;
yarn tufted into the backing, wherein yarn piles simulating grass blades project from the top face and yarn backloops are closely adjacent the bottom face; and
a porous coat of coating material that bonds the tufted yarn to the backing, wherein coating material is generally not disposed between the backing and the closely adjacent backloops.

16. The artificial turf of claim 15, wherein coating material does not fill a significant proportion of the backing's pores.

17. The artificial turf of claim 16, wherein the porous coat comprises a network of partly cohered particles of coating material.

18. The artificial turf of claim 15, wherein the turf has tuft bond strength of at least 12 pounds.

19. The artificial turf of claim 18, wherein water drains vertically through the artificial turf at a rate of at least 5 inches per minute.

20. The artificial turf of claim 15, wherein the coating material comprises at least one of the following: polyurethane, polyurea, a polyurethane/polyurea hybrid or a hot melt adhesive.
